(19) United States
(12) Patent Application Publication
(10) Pub. No.: US 2008/0202666 A1
(43) Pub. Date: Aug. 28, 2008

(54) Method for applying a rubbery mixture to a moving surface for the manufacture of tires

(75) Inventor: Serge Nicolas, Clermont-Ferrand (FR)

Correspondence Address: BUCHANAN, INGERSOLL & ROONEY PC, POST OFFICE BOX 1404, ALEXANDRIA, VA, 22313-1404, US

(73) Assignee: MICHELIN RECHERCHE ET TECHNIQUE S.A., Granges-Paccot (CH)

(21) Appl. No.: 12/068,338

(22) Filed: Feb. 5, 2008

Related U.S. Application Data
(62) Division of application No. 11/084,258, filed on Mar. 21, 2005.
Application No. 11/084,258 is a continuation of application No. PCT/EP03/10455, filed on Sep. 19, 2003.

(30) Foreign Application Priority Data
Sep. 25, 2002 (FR) 02/11875

(51) Int. Cl. B29D 30/62

(52) U.S. Cl. 156/96

(57) ABSTRACT

To recap a tire, hot rubber mix is applied under pressure to a receiving surface of the tire from a collecting b block disposed thereagainst while relative rotation occurs between the block and the tire. The block is configured to cause the hot mix to be pressurized as it approaches an exit orifice of the block which forms the hot mix into strip form, whereby the strip has a width less than one-tenth of the width of the receiving surface that is to be covered by hot mix.

### RELATED INVENTIONS

This application is a Division of U.S. Ser. No. 11/084,258 filed on Mar. 21, 2005, which is a Continuation of International Application PCT/EP03/010455 filed on Sep. 19, 2003, and claims priority from patent application Ser. No. 02/11875 filed on Sep. 25, 2002.

### BACKGROUND

The invention concerns a device for applying an uncured rubber mix to a moving surface for the manufacture of tires, in particular recapped tires.

As is known, most tires can be recapped, i.e. after the normal wear of the tire tread the said tread and even certain reinforcement plies of the tire belt can be replaced. These operations are very common for the tires of transport vehicles such as heavy vehicles, and can be carried out in actual factories or in workshops of larger or smaller size in which space problems and the need for flexibility of the machines are all-important factors.

There are two main types of recapping processes, one of them, commonly known as “hot recapping”, consisting in the positioning of an uncured tread, particularly in the form of sheets, strips or a section, onto a carcass ready to be recapped and then curing the whole in a mould; the other process, known as “cold recapping”, consists in using a pre-cured tire tread which is placed on a carcass ready to be recapped, and then vulcanizing the whole using heating means such as a stove.

In the present case it is mainly this second process that is of interest, in which an uncured layer of rubber mix is interposed between the carcass of the tire being recapped and the new tread, this layer being intended, after curing, to ensure a bond between the tire carcass and the tread. The layer of rubber mix is commonly called the “bonding rubber”.

The positioning of such bonding rubber poses many problems.

More and more, desiring to respect the environment, the use of rubber mixes dissolved in solvents and commonly used to constitute a kind of adhesive is avoided. This layer of adhesive is applied on the carcass being recapped before the positioning of a bonding rubber, to ensure correct positioning and bonding of the carcass with the latter.

There are several ways to achieve this imperative, one of these being to apply the bonding rubber while hot. Thus, publication EP-0 528 683 (corresponding to Bibona et al. U.S. Pat. No. 5,342,473) describes a device for applying a bonding rubber while hot, by means of a positioning head whose rubber application orifice covers simultaneously the full width of the carcass so that the whole of the layer of bonding rubber can be applied during a single revolution of the carcass. A high application pressure of this positioning head on the carcass enables filling of the holes likely to be present in the carcass during the application of the bonding rubber.

However, such a machine is found to be not very ergonomic and it involves a particularly bulky equipment configuration. On the other hand, it allows no adaptation to a second class of solutions which is becoming more and more common nowadays, namely the use of bonding rubbers having vulcanization systems that are extremely reactive at low temperatures. In effect, such bonding rubbers, which guarantee rapid curing rates and high cross-linking levels, often have very low stability in the uncured state. Finally, this machine does not allow the production of thin bonding rubbers (these having a minimum thickness, with the machine, of 1.4 mm), nor does it allow perfect control since the spreading of the bonding rubber simultaneously over the full width of the carcass results in appreciable variations of the thickness of the said rubber depending on whether it is on the crown or at the sides of the carcass.

A solution for reconciling the requirements of reactivity and stability of the vulcanization systems of these bonding rubbers, known as “accelerated”, consists in keeping the vulcanization agent and the vulcanization accelerators separate during storage and only bringing them into contact during the recapping operation itself, or storing the bonding rubber in refrigerated containers until it is used, to prevent premature vulcanization. In any case, this very high reactivity poses problems in terms of the storage of the products and their application to the carcass, since the reaction can occur inside the application device before the mix has been deposited on the carcass to be recapped or between two cycle times, or even during storage.

In what follows, rubber mixes are referred to as:
“normal” in the case of mixes whose time T0 to start vulcanization (usually known as the “scorch time”) is longer than 15 minutes at a temperature of 105° C.,
“accelerated” in the case of mixes whose time T0 is approximately between 7 and 15 minutes at 105° C.,
“ultra-accelerated” in the case of mixes whose time T0 is shorter than 7 minutes at 105° C.

In addition, the terms “small thickness”, “small width” and “high pressure” will be defined as follows:
“small thickness”, for a strip, will be defined as a mix thickness smaller than 2 mm, which can be down to 0.5 or even 0.1 mm,
“small width”, for a strip, will be defined relatively to the width of the surface to be covered, the width of the strip being less than one-tenth of the width to be covered,
“high pressure” for the application of a product in the form of a strip or some other shape on the receiving surface, will be understood to mean a pressure higher than 5*105 Pa.

Besides, it is also desirable to apply the bonding rubber in as thin a layer as possible so that the bond between carcass and tread will have the least possible impact on the performance or properties of the recapped tire, and also to minimize the quantity of product used. It is also desirable, however, to have sufficient flexibility to make it possible, while respecting that constraint, to vary the thickness of the layer so that it can, if necessary, plug any holes present on the surface of the carcass.

Similarly, nowadays it is also an advantage to be able to deposit a layer of bonding rubber on the outside of the sidewalls of tires in order to improve the aesthetic appearance of recapped tires and their protection against ozone, this being the same as saying that the application machine must be very versatile and flexible since, let it be remembered, the machine should be usable even in small workshops where this result cannot be achieved by having an installation of large size.

Note, finally, that the current present ultra-accelerated mixes cannot be used in an industrial context.

The purpose of the invention is to improve the carrying out of these operations.

### SUMMARY OF THE INVENTION

According to the invention, an apparatus is provided for applying a hot rubber mix under pressure in the form of a strip of small thickness and small width, onto a receiving surface of a tire moving relative to the apparatus. The apparatus comprises at least one extruder including of a body and a main extrusion screw mounted to rotate within a chamber. The main extrusion screw is designed to propel a rubber mix towards a first, intermediate extrusion orifice opening close to the receiving surface and located at the inlet of the zone ahead of a collecting block that cooperates with the receiving surface to form with the latter a second extrusion orifice defining the profile of the strip of rubber mix to be formed. The second extrusion orifice is delimited by a profiling wall of the collecting block on the one hand and by the receiving surface on the other hand. The front zone of the collecting block has a front wall that precedes the profiling wall and converges toward an inlet of the second extrusion orifice, wherein the application pressure of the mix at the inlet of the extrusion orifice is generated essentially by the effect of the degree of convergence associated with the speed at which the rubber mix is drawn along by the moving receiving surface relative to the collecting block.

This apparatus is found capable of depositing rubber strips of small thickness continuously onto a moving surface, and so fulfills the needs expressed by the recapping industry.

However, the apparatus is not limited to such use and there are numerous examples of its application in other fields.

### BRIEF DESCRIPTION OF THE DRAWINGS

Other advantages and characteristics of the invention will emerge from the descriptions of example embodiments of devices according to the invention for the application of rubber mixes, which refer to the drawings in which:

FIG. 1 is a partial axial cross-section of an application device according to the invention,

FIG. 2 is a partial section along the line 11 of the application device shown in FIG. 1,

FIG. 3 is a perspective view of a collecting block according to the invention,

FIGS. 4B and 4A show, respectively, a diagram of the pressure in the collecting block as a function of the distance of the mix in the said block relative to the extrusion orifice, and a partial axial section of the collecting block correlated with the diagram, and

FIG. 5 shows a schematic view of a hole detection system stuck to a collecting block.

### DETAILED DESCRIPTION OF A PREFERRED EMBODIMENT

In what follows, elements common to the different variant embodiments of the application device will be denoted by the same reference numerals.

Note that the receiving surface can be moving other than in rotation, the important feature being that it should be moving relative to the application device to enable the mix being deposited to be drawn along.

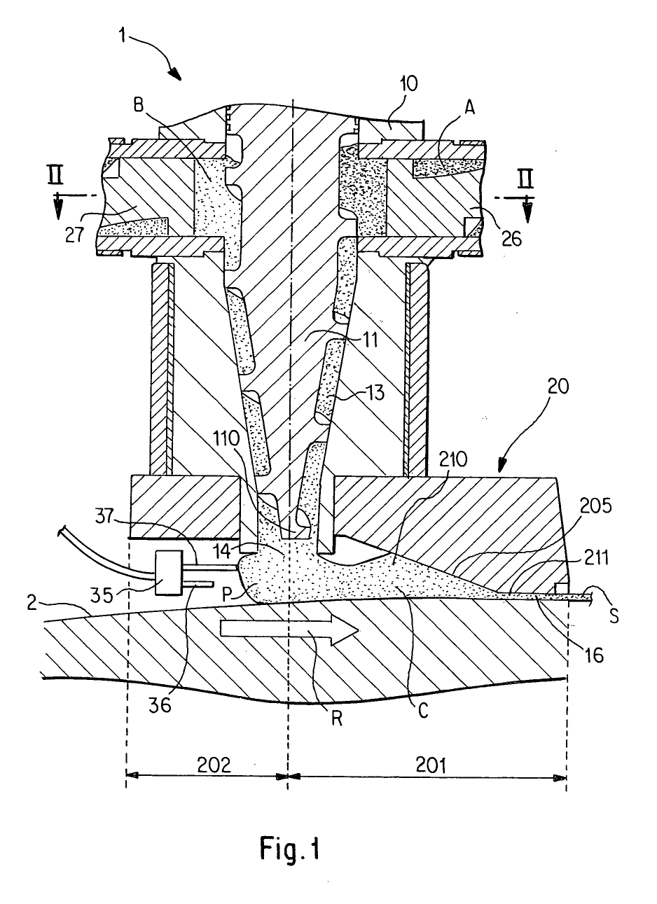

According to FIG. 1 the device 1 for applying a rubber mix C onto a receiving surface 2 comprises a body 10 with at least one extrusion screw 11 mounted to rotate within a chamber 13 ending at an intermediate extrusion orifice or mouth 14. The free or outlet end 110 of the screw 11 has a conical shape and extends directly as far as the boundary between the chamber 13 and the intermediate extrusion orifice 14 into which the chamber 13 opens.

Note that the invention is not limited to this mode of construction and that for less reactive mixes it is possible to have an extrusion screw that ends at an intermediate chamber of small size which can if necessary be curved for reasons of space, before opening into the extrusion orifice itself. However, the advantage of having an end of the screw which reaches down, i.e. close to the orifice 14 towards the outside of the chamber 13, is that there is no pressure at the end of the screw, which allows the latter to empty completely at the end of the operation. Thus, the embodiment of the invention shown in FIG. 1 is a self-emptying system, i.e. when the feed of mix to the screw is stopped, the screw will propel all the remaining mix to the outside of the screw.

To the end of the body 10 is attached a component 20 in the form of a collecting block 20 of essentially parallelepiped shape, which cooperates with the receiving surface to create a kind of extrusion blade at the level of an extrusion orifice 16 formed by the passage arranged between the receiving surface 2 and the profiling wall 211 of the collecting block 20.

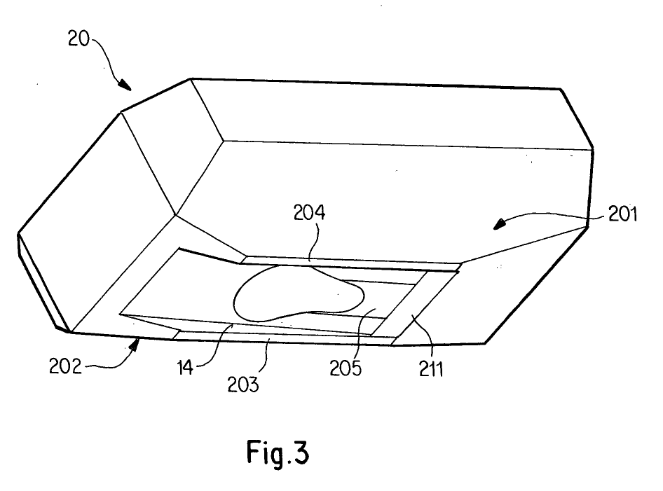

A collecting block 20 according to the invention is shown in perspective in FIG. 3. This collecting block extends parallel to the movement direction of the receiving surface 2 indicated by the arrow R in FIG. 1, and has a front zone 201 and a rear zone 202, having regard to the translation direction of the surface 2.

The collecting block also has two lateral flanges 203 and 204 which delimit the width of the extrusion orifice 16 in a direction perpendicular to the translation direction of the receiving surface 2. These flanges 203 and 204 extend in the longitudinal direction as shown in FIG. 3, so as also to act as sealing lips that ensure close contact with the receiving surface 2 and so delimit the width of the strip S being formed on contact with the surface 2. The flanges 203 and 204, together with a front wall 205 of the collecting block, form a cavity 210 in which the mix is compressed. Note in fact that these flanges 203 and 204 can consist of simple ridges which suffice to ensure the lateral sealing of the cavity of the collecting block.

The front wall 205 converges toward an inlet of the extrusion orifice 16 to guide or funnel hot rubber mix toward that inlet as the mix is advanced by the moving receiving surface 2.

The extrusion screw 11 ends at the intermediate extrusion orifice 14 located between the two zones 201 and 202. At the outlet of the chamber 13, the rubber mix is first deposited on the receiving surface 2 and then, under the effect of the relative movement R of the latter, it is transported to the level of the cavity 210 formed by the wall 205 of the front position 201 of the collecting block 20 and finally makes its way to the extrusion orifice 16 to form a strip S of small thickness deposited uniformly over the receiving surface 2.

The converging profile of the wall 205 upstream from the profiling wall 211 is adapted so as to force the mix to spread more evenly over the full width of the profiling wall. To that end, the profile is designed to create, with the relative movement of the reception surface, a “dynamic pressure” under the blade so as to form a strip S of constant thickness and width and to apply the mix onto the receiving surface 2 under the best possible conditions by impregnating with the mix any surface irregularities such as carding grains, repair holes or the junctions of individual strip turns.

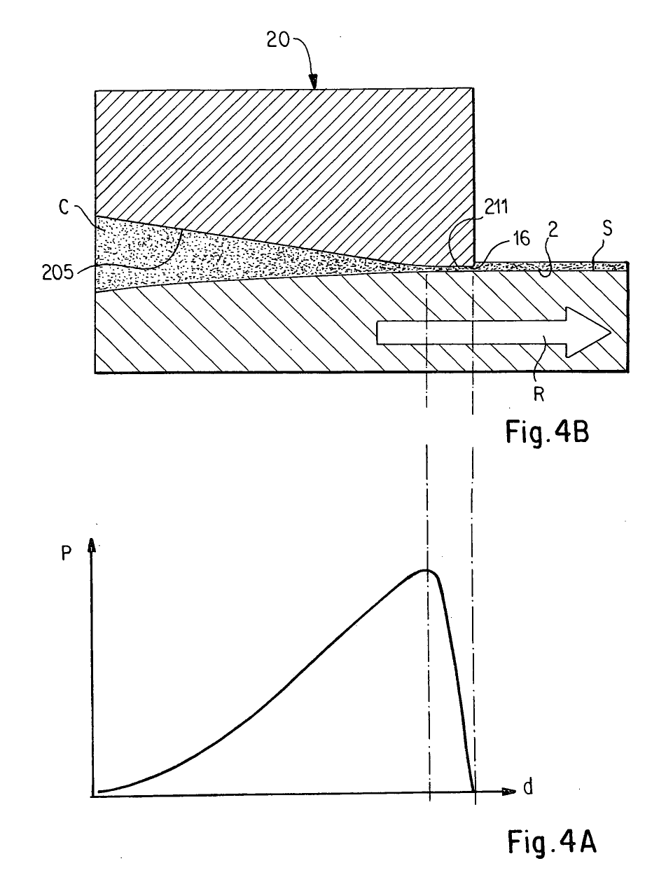

The diagram shown in FIG. 4A illustrates this phenomenon since it represents the evolution of the pressure P (ordinate) as a function of the distance d (abscissa) of the mix inside the collecting block as far as the outlet point of the extrusion orifice 16 formed by the receiving surface 2 and the profiling wall of the collecting block, as shown schematically by the section of the block shown in FIG. 4A which correlates with FIG. 4B. In FIG. 4A a mix C is seen to appear in the cavity 210 of the front zone 201 of the collecting block 20. The front wall 205 creates with the latter an angle effect in the outlet zone of the mix outside the collecting block, the arrow R representing the movement direction of the surface 2. It can be seen that there is a very large pressure peak of short duration at the moment when the mix C moves into the extrusion orifice 16 at the outlet of the collecting block 20, where the maximum effect given by the angle is produced, which corresponds to a high application pressure of the mix. Thus, at the inlet of the extrusion orifice 16 a pressure can be obtained which locally exceeds 2*106 Pa.

At the inlet of the cavity 210 of the collecting block and at the level of the intermediate extrusion orifice 14, the pressure is essentially zero without disturbing this phenomenon of dynamic pressurization whose action contributes to the profiling of the rubber C at the outlet of the orifice 16.

The front wall is preferably flat and forms an acute angle with the receiving surface. The value of that angle is not necessarily determined precisely but must be small enough, i.e., less than 30°, preferably between 5° and 10°, to create this dynamic effect. The translation speed of the receiving surface relative to the collecting block is also a first-order factor that enables the dynamic pressurization effect to be obtained. This speed can range from 0.2 to 3 m/s and is more preferably from 0.8 to 1.5 m/s, depending on the nature of the mix, the angle of the front wall and the thickness of the strip.

Of course, other shapes can be considered for the structure of the collecting block (e.g., a convexly curved front wall 205), but the form depicted in the drawings has the advantage of simplicity while guaranteeing the profile of the strip S so formed, in terms of width and thickness.

At the level of the extrusion orifice 16, the front zone 201 has a profiled wall 211 which, as has been said, constitutes a kind of profiling blade together with the rotating receiving surface 2, this determining the profile and a substantially “constant” thickness of the strip S. The distance between the profiling wall 211 and the receiving surface 2 is less than 1 mm and generally between 0.1 and 0.5 mm, to give strips of the order of 0.1 mm to 1 mm thick. This height of the strip S is thus always slightly larger than the height of the blade and is regarded as constant relative to the mean profile of the receiving surface. In effect, as will be seen in more detail below, the entry flow-rate of the mix and/or the deposition rate can be manipulated to enable filling of the holes present on the carcass, consequently obtaining a strip which is locally thicker in absolute terms but which remains essentially of constant thickness relative to the said mean profile.

To regulate the flow of mix at the end of the screw 13, it may be advisable in the configuration illustrated in FIG. 1 to allow a bead P to form in the rear portion 202 of the collecting block, which can satisfy a momentary mix consumption larger than average and associated for example with the presence of a hole. This bead P can be regulated very simply with the help of a detection probe 35 comprising two feelers 36 and 37, to detect respectively the opposite top and bottom positions of the bead. Those with knowledge of the field will be able to use other techniques to evaluate the size of the bead, using for example the incidence of a laser beam or else proximity detectors.

It is then possible for an automatic control system to act upon the feeding of the extrusion tool, for example by varying the speed of the screw or the translation speed of the receiving surface.

Note that in the case when the receiving surface is rotating, varying of the circumferential speed entails taking into account the inertia of the rotating masses. In practice, this speed will be kept relatively constant.

The rear zone 202 has no rear edge or lip that would if necessary transversely close off the extrusion orifice in contact with the surface, since the drawing of the mix towards the front of the collecting block does not require the rear zone to be closed.

To ensure proper functioning of the collecting block it is appropriate to exert an application force on the device as a whole, in a direction substantially perpendicular to the receiving surface at the point of application of the collecting block, which only serves to maintain contact between the flanges 203 and 204 and the receiving surface 2. This force is relatively modest, of the order of 500 to 1000 N, which limits the mechanical stresses applied to the system.

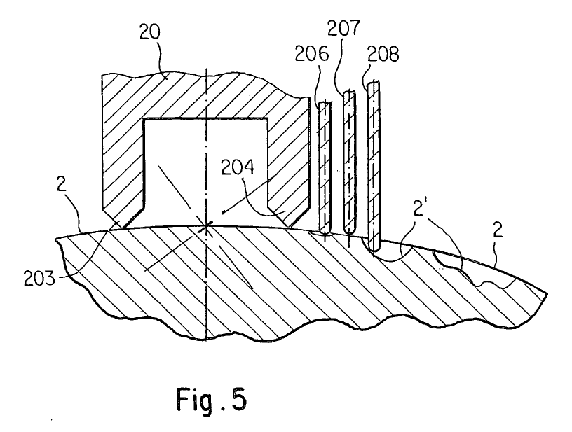

To anticipate an additional momentary consumption of mix related to the presence of holes, and when the receiving surface is rotating, one could also consider arranging, laterally relative to the extrusion orifice, i.e. transversely with respect to the receiving surface and close to the said surface 2, a hole detector such as that shown in FIG. 5 which enables the position of large holes to be noted one revolution before the passage of the application device, and so to anticipate a change of the entry flow-rate of the mix into the application device. This detector can consist for example of one or more feelers 206, 207, 208 which are actuated when the real circumferential profile 2′ of the receiving surface is lower than the mean profile 2 of the said surface. The mean profile is given with reference to the position of the feelers relative to the position of the collecting block. The advantage of using several feelers, namely three feelers in the example shown in FIG. 5, lies in the greater precision with which holes can be located. When a hole is noted, the automatic control system records its azimuth on the circumference of the receiving surface and anticipates the increase of the screw's speed during the next revolution, so as to make available a larger amount of rubber at the collecting block when the latter passes over the hole to be plugged. In the presence of a large hole a change can be anticipated in the rotation speed of the screw but also in the circumferential speed of the receiving surface, so that effects related to the inertia of the rotating units are minimized.

It is important to say that for the application of depositing a bonding rubber and when, while blocking holes, it is sought to minimize the quantity of product deposited, blocks can be made in which the volume available for the mix is of the order of a few grams, which can for example enable a strip about 10 to 20 mm wide to be produced. This example, however, in no way limits the scope of the invention, and the application device can also be particularly interesting for the deposition of products other than bonding rubber.

In what follows it will also be seen that the possibility of having an extremely small volume in the collecting block enables the use of ultra-reactive products, which cannot always be used at present.

Besides a single rubber mix, the device according to the invention can also be used for the deposition of mixes whose reactivity is such that the vulcanization system of the mix is divided into two products A and B which, once combined, react very rapidly and can vulcanize in a few minutes (less than 7 minutes at temperatures close to 100° C.).

With such mixes the products A and B must be mixed rapidly and thoroughly and the system must be self-emptying with very small quantities of mix and with a very short dwell time in the device between the start of mixing and the deposition of the mix C obtained, to avoid any vulcanization inside the equipment.

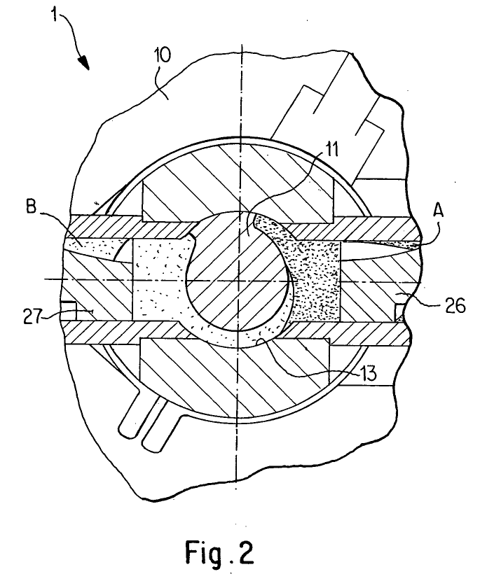

The invention provides a solution for these problems thanks to the use of a collecting block with a feeding system that uses, in addition to the screw 11, at least two other extrusion screws 26 and 27 which can be seen in FIGS. 1 and 2. These extrusion screws 26 and 27, fed respectively with the products A and B, are arranged for example perpendicularly to the extrusion screw 11 and diametrically opposite one another or, on the contrary, with a small angle between their two outlets. The screws 26 and 27 lead to the extrusion screw 11 which mixes A and B rapidly before propelling the mixture so produced towards the intermediate extrusion orifice 14.

In the case of extremely reactive products considered here, it can be advantageous for the extrusion screws 26 and 27 to have conical ends opening as close as possible to the extrusion screw 11 in order to facilitate mixing and the emptying of the equipment. The products A and B then pass directly into the conical portion of the extrusion screw 11 where they are simultaneously mixed and propelled towards the intermediate extrusion orifice 14. This enables extremely reactive products to be deposited without vulcanization taking place inside the extrusion device.

When the feed screws stop, the screw 11 empties totally because it opens into the intermediate extrusion orifice 14, where the pressure is essentially equal to zero. Moreover, the collecting block also empties completely because of the small volume contained in the bead and in the cavity 210. In this way the mixture of products A and B is deposited on the receiving surface 2 a few fractions of a second after having been made.

Another application of the invention is particularly interesting and concerns all the situations encountered during the production of tire covers when it is necessary to improve the quality of the interfaces between two rubber layers of different natures, or even when it proves essential to improve the uncured adhesion of a profiled element. To solve these problems the traditional approach is to use dissolution based on rubber mix and solvent. However, the toxicity of the vapors of these solvents is harmful and their use should be avoided by any possible means. It is therefore easy to imagine that a device such as that proposed in the invention, is particularly suitable for depositing a strip S of rubber mix of very small thickness on the surface of a tire being fabricated. This layer of rubber, a few hundredths of a millimeter thick, advantageously replaces any solvent-based dissolution and represents a quantity of material equivalent to that deposited in the earlier situation.

Thus, such a device enables a strip to be deposited on a receiving surface that is moving relative to a collecting block. It can easily be mounted on a robot that enables the movements of the device to be controlled in a direction transverse to the movement of the receiving surface so as to obtain products of very diverse forms.

Moreover, the application pressure of the mix is perfectly satisfactory for the formation of good quality junctions between the strips deposited during successive revolutions of a rotating receiving surface such as a tire carcass to be recapped.

Although the present invention has been described in connection with preferred embodiments thereof, it will be appreciated by those skilled in the art that additions, substitutions, deletions, and modifications may be made without departing from the scope of the application.

1. A method of applying hot rubber mix under pressure to a given width of a receiving surface of a tire, said strip having a width less than one-tenth of the width of the tire, comprising the steps of:
A) actuating a main extrusion screw within a cavity to propel hot rubber mix towards a first extrusion orifice that opens proximate the receiving surface within a front zone of a collecting block disposed against the receiving surface; and
B) producing relative rotary movement between the collecting block and the receiving surface for advancing the hot rubber mix toward a second extrusion orifice formed between the receiving surface and a profiling wall of the collecting block which forms a strip of hot rubber mix having a width less than one-tenth of the given width of the receiving surface;
C) prior to the hot rubber mix reaching the second extrusion orifice, causing the hot rubber mix to travel along a front wall of the collecting block which converges toward an inlet of the second extrusion orifice to cause a pressure to be applied to the hot rubber mix as a function of: a degree of convergence of the front wall and a relative speed of movement between the receiving surface and the collecting block, and
D) winding spirally the strip around the surface of the receiving surface to cover the given width thereof.

2. The method according to claim 1 wherein the relative speed of movement is in the range of 0.5 m/s to 4.0 m/s.

3. The method according to claim 2 wherein the front wall is substantially flat and forms an angle with the collecting surface which is smaller than 30°.

4. The method according to claim 1 wherein the collecting block is pressed against the receiving surface with a force not exceeding 1000 N.

5. The method according to claim 3 wherein the pressure of the hot rubber mix at the first extrusion orifice is substantially zero.

6. The method according to claim 3 wherein the speed of the main extrusion screw and the relative speed of movement are monitored in accordance with the size of a bead of hot rubber mix located at the rear zone preceding the front zone.

7. The method according to claim 1 wherein the tire is a tire being recapped.
